(19) United States
(12) Patent Application Publication
(10) Pub. No.: US 2015/0109885 A1
(43) Pub. Date: Apr. 23, 2015

(54) METHOD FOR CORRECTING FIRST BREAK ARRIVAL TIME

(71) Applicant: CONOCOPHILLIPS COMPANY, Houston, TX (US)

(72) Inventors: Ethan J. NOWAK, Cypress, TX (US); Vaughan L. BALL, Houston, TX (US)

(21) Appl. No.: 14/494,245

(22) Filed: Sep. 23, 2014

Related U.S. Application Data
(60) Provisional application No. 61/883,027, filed on Sep. 26, 2013.

(51) Int. Cl. G01V 1/40

(52) U.S. Cl. CPC G01V 1/40; G01V 2210/59
USPC 367/25

(57) ABSTRACT

The present disclosure cointegrates the traveltimes obtained from checkshot survey and integrated sonic log in obtaining a corrected traveltimes to more accurately determine the first break in seismic data.

### CROSS-REFERENCE TO RELATED APPLICATIONS

This application is a non-provisional application which claims benefit under 35 USC §119(e) to U.S. Provisional Application Ser. No. 61/883,027 filed Sep. 26, 2013, entitled “METHOD FOR CORRECTING FIRST BREAK ARRIVAL TIME,” which is incorporated herein in its entirety.

### FEDERALLY SPONSORED RESEARCH STATEMENT

Not applicable.

### FIELD OF THE DISCLOSURE

The disclosure relates to a method for automatically picking the first break, especially by co-integrating the traveltimes of a sonic log and a checkshot survey.

### BACKGROUND OF THE DISCLOSURE

In the oil and gas industry, geophysical prospecting techniques are commonly used to aid in the search for and evaluation of subterranean hydrocarbon deposits. Generally, a seismic energy source is used to generate a seismic signal, which propagates into the Earth and is at least partially reflected by subsurface reflectors (i.e., interfaces between underground formations having different acoustic impedances). The reflections are recorded by seismic detectors located at or near the surface of the Earth, in a body of water, or at known depths in the boreholes. The resulting seismic data may be processed to yield information relating to the location of the subsurface reflectors and the physical properties of the subsurface formations.

Subsurface geological modeling includes predicting key petrophysical property variables of interest such as water saturation, porosity, and permeability for development planning and production forecasting. These target variables are measured at locations where sampling tools can be run through the subsurface within wells. The geological model at these sample locations is conditioned by such measurements with little or no attached uncertainty. At unsampled locations beyond and between wells, however, the geological model requires predictions of the target variable resulting in a degree of uncertainty in those predictions.

Information concerning the characteristics of subterranean formations can be obtained by investigating acoustic waves that have propagated through at least a portion of the formation. Typically the investigation involves emitting one or more types of wave into the formation at one location, recording the wave at another location after it has passed through the formation, and analyzing how the wave has been affected by its travel through the formation.

To establish a time-depth relationship, two data types can be considered: the time-depth function resulting from a checkshot survey, and an integrated sonic log. Both sample the same subsurface property but in a different fashion, hence they are subject to different error models. Sonic logging is a well logging tool that provides a formation's interval transit time, designated as Δt, which is a measure of a formation's capacity to transmit seismic waves. Geologically, this capacity varies with lithology and rock textures, most notably decreasing with an increasing effective porosity. This means that a sonic log can be used to calculate the porosity of a formation if the seismic velocity of the rock matrix, Vₘₐₜ, and pore fluid, V₁, are known, which is very useful for hydrocarbon exploration.

The velocity is calculated by measuring the travel time from the piezoelectric transmitter to the receiver. To compensate for the variations in the drilling mud thickness, there are actually two receivers, one near and one far. This is because the travel time within the drilling mud will be common for both, so the travel time within the formation is given by:

Δt=t_{far}−tₙₑₐᵣ;

where t_{far}=travel time to far receiver; tₙₑₐᵣ=near travel time to near receiver.

This tool design is incapable of accounting for the frequency dependence of acoustic velocity. This amounts to an anomalously fast measurement increasing with depth from the seismic data perspective.

The seismic reference survey (SRS), also referred to as a seismic check shot survey, is used as a calibration mechanism for the above-discussed reflection seismic data. In this survey, seismic velocities are measured in the borehole by recording the time required for a seismic pulse generated by a surface energy source to reach a geophone anchored at different levels in the boreholes, typically spaced apart by 100 meters or 500 feet. Vertical seismic profiles are then made based on the full seismic trace received downhole at each detector. Automatically picking first break (the onset arrivals of refracted signals from all the signals received by the receiver and produced by a particular source signal generation) then provides the time-velocity-depth data that is later processed to display a relatively noise-free seismic section near the wellbore.

As shown in FIG. 1, one common device for this investigation technique is a sonde 10 disposed in a wellbore 5 for transmitting and receiving acoustic signals. As shown, the sonde 10 is tethered to a wireline 9, control commands are provided to the sonde 10 via the wireline 9 and data recorded by the sonde 10 may be transmitted back through the wireline 9 to a surface truck 2. The sonde 10 is shown having an acoustic transmitter T₁ for creating and transmitting the acoustic signals into the formation. Also included with the sonde are multiple receivers (R₁-R_{M}) disposed along the length of the sonde for receiving the acoustic signals as they have passed through the formation.

FIG. 2 provides an example of acoustic data 12 sampled by the sonde of FIG. 1. The acoustic data 12 comprises waveforms that represent acoustic signals (A₁-A_{M} received by the respective receivers (R₁-R_{M}). Each waveform has a noise portion (N₁-N_{M}) that represents ambient noise signals recorded by each receiver and a signal portion (S₁-S_{M}) that represents the transmitted signal from the transmitter as received by the receivers. The point on the waveform at the beginning of the signal portion is typically referred to as the “first break” or “first arrival” of the acoustic signal. The moveout or slowness of the waveforms can be determined by creating a line 14 that intersects the first break of each waveform and taking the slope of that line 14.

In this kind of diagram, the sonic data are measured as “slowness”—μs/ft: the transit times (in microsecond) of sonic energy across a several foot interval. These data are summed to any depth to give a total traveltime called the integrated sonic time. Identifying the first break of a signal can be difficult since the magnitude of the ambient noise often equals or exceeds that of the signal itself. One technique for identifying this break point relies on the assumption that the acoustic signal received by each receiver (R₁-R_{M}) will largely have the same form. The technique involves comparing portions of the waveform of the signals (A₁-A_{M}), the initial point at which these forms largely match is determined to be the first break. However, ambient noise or noise from a monitoring device can be received by the receivers and mistaken for the actual signal—this is often referred to as a “false signal” or “false” first break detection. Thus, due to the potential for detecting false signals, improved techniques for first break identification are still desired.

The checkshot survey relies on first break picking on vertical seismic profiles (VSP). Random and coherent noises, bandwidth changes, preferential propagation paths, to name a few, all contribute to small random errors when estimating the first arrival of the acoustic waveform. A delayed pick results in an artificially slow interval overlying an excessively fast interval and vice versa.

Attempts to remedy miss-picked checkshot surveys fall into two categories: smoothing and manual intervention. Smoothing, whether it is spline interpolation, culling or 2^{nd} and 3^{rd} order polynomial fitting, cause a variety of artifacts in the time-depth relationship.

For polynomial fits, it tends to produce an overly smooth and simplistic slowness trend incapable of addressing subtle changes in acoustic velocity.

Culling produces a coarse and blocky slowness profile, also incapable of addressing smaller scale changes in acoustic velocity.

Spline interpolation exactly matches the checkshot picks, which arguably are prone to errors, and smoothly interpolates between picks.

Manual intervention often occurs during the well-to-seismic tie facilitated by synthetic seismogram. Experienced geophysical and petrophysical practitioners have cautiously and successfully remedied flawed checkshot surveys, however without this experience the quality of the time-depth relationship typically degrades.

As discussed above, first-break picking is that of detecting or picking the onset arrivals of refracted signals from all the signals received by the receiver arrays and produced by a particular source signal generation, it is also called first arrival picking or first break detection. First-break picking can be done automatically, manually or as a combination of both. With the development of computer science and the size of seismic surveys, automatic picking is often preferred

The error in first break picking may be quite significant. For example, it has been reported that a 0.5 ms error in time over a 25 ft vertical seismic profile (VSP) interval with a true interval velocity of 15,000 ft/s gives an observed velocity of 11,537 ft/s, a 23 percent error.

Automatic first break picking has been known in the field. Gelchinsky and Shtivelman used correlation properties of signals and applied to statistical criterion for the estimation of first arrival time. Coppens calculated the ratio of energy of seismogram of two windows and used that to differentiate in signal and noise. McCormark et al. introduced a back propagation neural network (BNN) method. The Neutral network which edits seismic data or pick first breaks was trained by users, who were just selecting and presenting to the network examples of trace edits or refraction picks. The network then changes internal weights iteratively until it can reproduce the examples accurately provided by the users.

Fabio Boschetti et al. (1996) introduce a fractal-based algorithm, which detects the presence of a signal by analyzing the variation in fractal dimension along the trace. This method works when signal-to-noise ratio is small, but it is considerably slow. A direct correlation method was introduced by Joseph et al. (1999), which was developed for use in highly time-resolved, low-noise signals acquired in the laboratory. In this method, the greatest value of Pearson's correlation coefficient between segments of observed waveforms near the pulse onset and at an appropriate reference serves as the time determination criterion.

Zuolin Chen, et al. (2005) introduced a multi-window algorithm to detect the first break. In this method, three moving windows were used and the averages of absolute amplitudes in each window need to be calculated, then ratios based on the averages of the windows provide standards to differentiate signals from unwanted noise. Wong et al. (2009) introduced STA/LTA ratio method. This method is similar to Coppens' algorithm. The difference is to calculate the ratio of two averages of energy between a short-term window and a long-term window, which is denoted as STA/LTA (short-term average/long-term average), instead of calculating the ratio of energy of seismogram of the two windows in Coppens' algorithm.

In the STA/LTA method, the numerical derivative of the ratio can be defined as,

dᵢ=rᵢ₊₁−rᵢ,i=1,2, . . . (n−1)

where rᵢ₊₁ is the STA/LTA ratio at time index i+1, and rᵢ is the STA/LTA ratio at time index i. For noise-free seismograms, the maximum value of the numerical derivative of the STA/LTA ratio is close to the time of the first arrival.

U.S. Pat. No. 7,660,199 provides another forward modeling of detecting first breaks. The method includes providing an estimate of space for a location of a source of the microseismic event, the estimate being at least partially based on an estimated relative location of a tool and the microseismic event; providing an estimate of a velocity model for a formation; receiving data of the microseismic event with a first and a second seismic sensor located on the tool in a wellbore, the data including at least a P-wave and an S-wave component; selecting at least a first and a second instant in time; and utilizing the receiving data to determine a first break using forward modeled traveltimes.

U.S. Pat. No. 7,646,673 provides a mapping method for identifying first breaks by first recording acoustic waves from within the formation wellbore, creating a semblance plot based on the recorded waves, generating a phase separation plot, and then identifying the first break by combining the phase line plot and the semblance plot.

U.S. Pat. No. 5,181,171 provides a method of operating an adaptive network to determine a first break, in which the network includes stored seismic trace data. The method includes training the adaptive network according to the generalized delta rule, and once trained, is provided with the inputs of averaged graphical data corresponding to multiple seismic traces, each over a period of time. The network iterates in steps of time for the multiple traces, and indicates with one output that the first break is later than the time of interest, and with another output that the first break is at or prior to the time of interest. The time at which the outputs change state indicates the first break for the trace.

However, none of these first-break picking methodologies provide accurate enough results.

Co-integration is a concept invented by Nobel laureate Clive Granger in building macroeconomic models. Prior to that, macroeconomic models were built based on the assumption that variables in the models are non-stationary, (by “stationary” it means that the variables return to a fixed value or fluctuate around a linear trend). To test the validity of these models, it is important to perform empirical research based on the aggregate variables. Before Granger, the statistical theory that was applied in building and testing large simultaneous-equation models was based on the assumption that the variables in these models were stationary. But then the problem would arise when the statistical inference associated with the stationary processes is no longer valid if the time series are indeed realizations of nonstationary processes. Granger showed that macroeconomic models containing nonstationary stochastic variables can be constructed in such a way that the results are both statistically sound and economically meaningful.

For a long time it was common practice to estimate equations involving nonstationary variables in macroeconomic models by straightforward linear regression. It was not well understood that testing hypotheses about the coefficients using standard statistical inference might lead to completely spurious results.

Therefore, it is desirable to apply the co-integration concept in the seismic field to more accurately determine the first break by co-integrating the checkshot survey traveltimes with sonic logs.

### SUMMARY OF THE DISCLOSURE

The present disclosure provides a novel method for correcting a checkshot survey traveltime. In particular, we employ the co-integration concept to co-integrate the traveltimes obtained from a checkshot survey and a sonic logging, thereby minimizing the errors inherent in the first-break picking in the checkshot survey. As discussed below, the method of the present disclosure reconciles the time-depth relationship between the checkshot survey and integrated sonic log, enables the reduction of checkshot measurement errors, which will reduce manual editing of time-depth relationship and eliminate the need for artifact-prone smoothing operations.

As used herein, “checkshot survey” means a method for measuring and establishing vertical seismic profile by putting seismic sensors at different depths of a downhole to sense and record seismic signal from a source.

As used herein, “sonic log” means a well logging tool that provides a formation's interval transit time, which is a measure of a formation's capacity to transmit seismic waves.

As used herein, “traveltime” means the arrival times, commonly P or S waves, recorded at different points as a function of distance from the seismic source. Seismic velocities within the earth can be computed from the slopes of the resulting curves.

As used here, “regression coefficient” means when the regression line is linear (y=ax+b) the regression coefficient is the constant (a) that represents the rate of change of one variable (y) as a function of changes in the other (x); it is the slope of the regression line.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

The phrase “consisting of” is closed, and excludes all additional elements.

The phrase “consisting essentially of” excludes additional material elements, but allows the inclusions of non-material elements that do not substantially change the nature of the invention.

The following abbreviations are used herein:

| Abbreviation | Term |
|---|---|
| SRS | Seismic reference survey |
| VSP | Vertical seismic profile |

### BRIEF DESCRIPTION OF THE DRAWINGS

A more complete understanding of the present invention and benefits thereof may be acquired by referring to the follow description taken in conjunction with the accompanying drawings in which:

FIG. 1 shows a reference mechanism for conducting a checkshot survey.

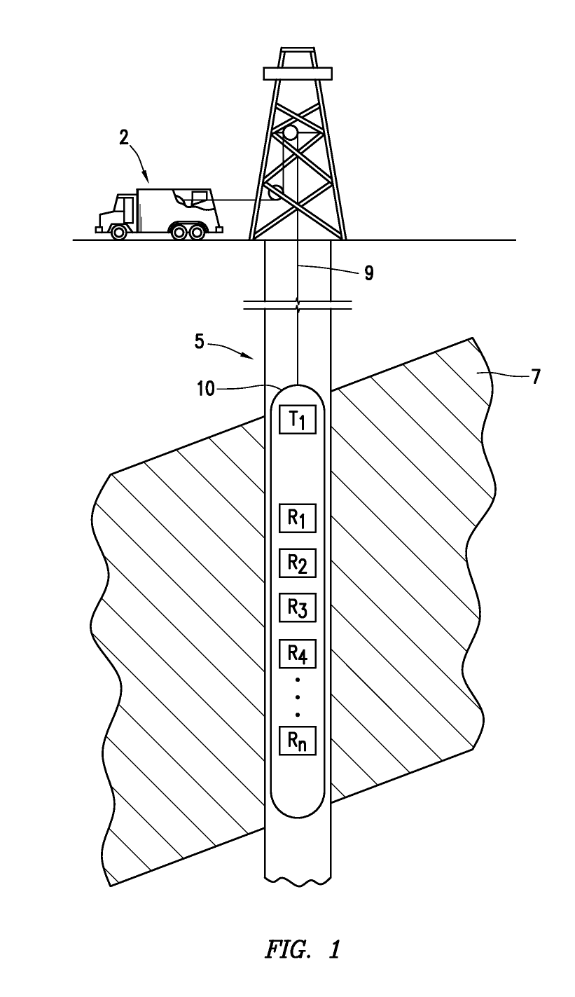

FIG. 2 shows sample results of a checkshot survey, in which first breaks are picked as the onset of arrival signals at different receivers.

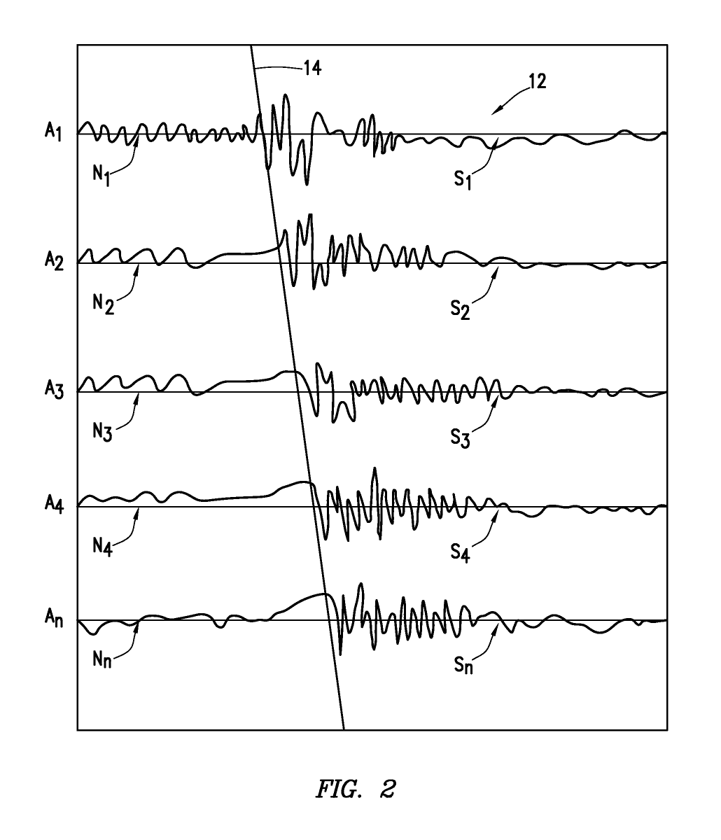

FIG. 3 show a checkshot p/s wave diagram obtained from a wellbore.

FIG. 4 shows a sample sonic log data from an existing wellbore.

FIG. 5 is a flow diagram for correcting a checkshot survey traveltime.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

In one or more embodiments, the disclosure provides a method for picking the first break arrival signal of a seismic survey, comprising the steps of:
a) obtaining a checkshot traveltime tc from a checkshot survey time-depth relationship, wherein said checkshot survey is conducted using sensors located at different depths of a wellbore;
b) obtaining a sonic log traveltime ts from a sonic log time-depth relationship from the same wellbore; and
c) applying equation (4) to obtain a time-depth correction tcorr:

t_{corr}^{est}=[G^{T}G+λ²I]⁻¹G^{T}[a₀+a₁a₂D₁tₛ+a₃D₂tₛ−Gt_{c}] (4)

Preferred methods, further comprise performing step b-1) prior to step c):

b-1) resampling ts from said integrated sonic log at the same depths as the checkshot survey.

In other embodiments, an improved method of picking the first break arrival signal of a seismic survey is provided, the improvement comprising determining the first break by co-integrating a checkshot survey traveltime with a sonic log traveltime.

Another improved method of picking the first break arrival signal of a seismic survey is provided, the improvement comprising obtaining a checkshot survey and a sonic log, limiting the time-depth relationship resulting from the checkshot survey tc and integrated sonic log ts to consistent time coverage; resampling the integrated sonic log at the checkshot measurement depths, thereby co-integrating a checkshot survey traveltime with a sonic log traveltime and picking a more accurate break arrival signal.

Petrophysical properties are often related to seismic or elastic attributes such as p/s-wave velocity that can be derived from the inversion of seismic reflection data. These relationships are generally referred to as rock physics relationship and quantified with correlation coefficients derived from collocated pairs of target variables and inverted elastic attributes. To reduce prediction uncertainty and better characterize the subsurface, rock physics relationships can be honored during prediction.

Seismic inversion is the process of transforming seismic data into a quantitative rock property description of the subterranean geological formation beneath the surface of the earth. As such, seismic inversion models fundamental rock property from pre-stack or post-stack seismic data, such as acoustic impedance. These fundamental rock properties from the seismic data are used to create a description of hydrocarbon deposits in the subterranean geological formation, such as reservoirs. This description is then used to model hydrocarbon production and estimate reserves.

The data preparation consists of: (1) Limit the time-depth relationship resulting from the checkshot survey t_{c} and integrated sonic log tₛ to consistent coverage; (2) resample the integrated sonic log at the checkshot measurement depths.

The algorithm begins with the single equation Error Correction Model:

D₂t_{c}=a₀−a₁D₁t_{c}+a₁a₂D₁tₛ+a₃D₂tₛ+ε (1)

where D₁ is the I^{th} derivative operator, a₁ is the I^{h} order regression coefficient and ε refers to the zero mean, finite variance, random measurement error.

By defining the operator G=D₂+a₁D₁, the above equation (1) can be reduced to:

Gt_{c}=a₀+a₁a₂D₁tₛ+a₃D₂tₛ+ε (2)

Making tₜᵣᵤₑ=t_{c}+t_{corr}, such that the portion of slowness disequilibrium accounted for by the slowness correction is removed:

G[t_{c}+t_{corr}]=a₀+a₁a₂D₁tₛ+a₃D₂tₛ+ε (3)

For equation (3), the least squares solution that solves t_{corr} that minimizes ε is

t_{corr}^{est}=[G^{T}G+λ²I]⁻¹G^{T}[a₀+a₁a₂D₁tₛ+a₃D₂tₛ−Gt_{c}] (4)

Reducing the dependence of manual intervention and eliminating the application of smoothing functions are the main advantages of this approach. This is facilitated by employing the sonic log in a mathematically sound fashion to correct the error prone checkshot survey. The features reduce artifacts, minimize the possibility for operator error, and increase well-to-seismic tie efficiency.

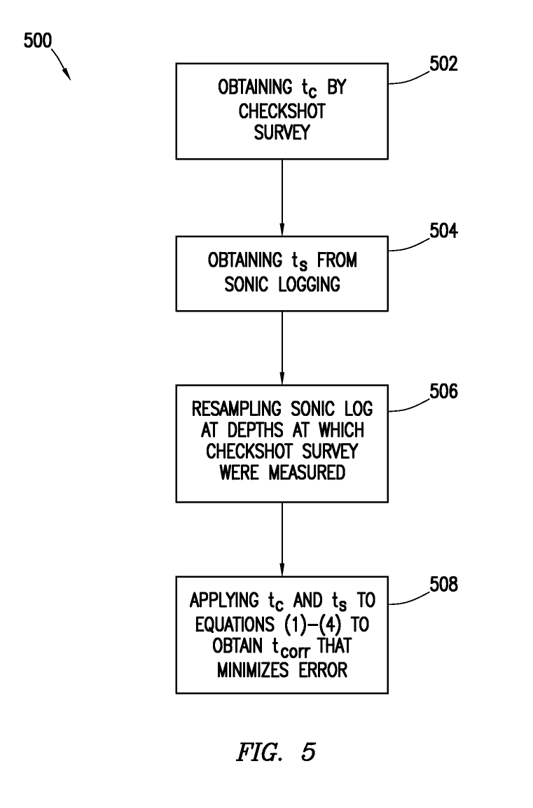

Therefore, the method 500 of the present disclosure is illustrated in FIG. 5. Step 502 is obtaining the traveltime t_{c} by conducting a checkshot survey. Step 504 is obtaining traveltime tₛ from sonic logging. Step 506 is resampling the sonic logging at the checkshot survey measurement depths for proper co-integration. And lastly in step 508 t_{c} and tₛ are applied to the above-described equations to obtain the estimated correction time t_{corr}^{est}.

The following examples of certain embodiments of the invention are given. Each example is provided by way of explanation of the invention, one of many embodiments of the invention, and the following examples should not be read to limit, or define, the scope of the invention.

### Obtaining Checkshot Survey Time T_{c}

By measuring the travel time of a first arrival wave from the seismic receiver at the location of the virtual source to another seismic receiver, a local seismic velocity may be determined. This will hereinafter be referred to as a virtual check shot. When the travel times of the first arrival waves from the virtual source to a number of seismic receivers below it, a seismic velocity profile may be constructed that is insensitive to overburden complexity. The virtual check shot can correct for overburden of any complexity since no velocity information between the surface and the seismic receivers is required.

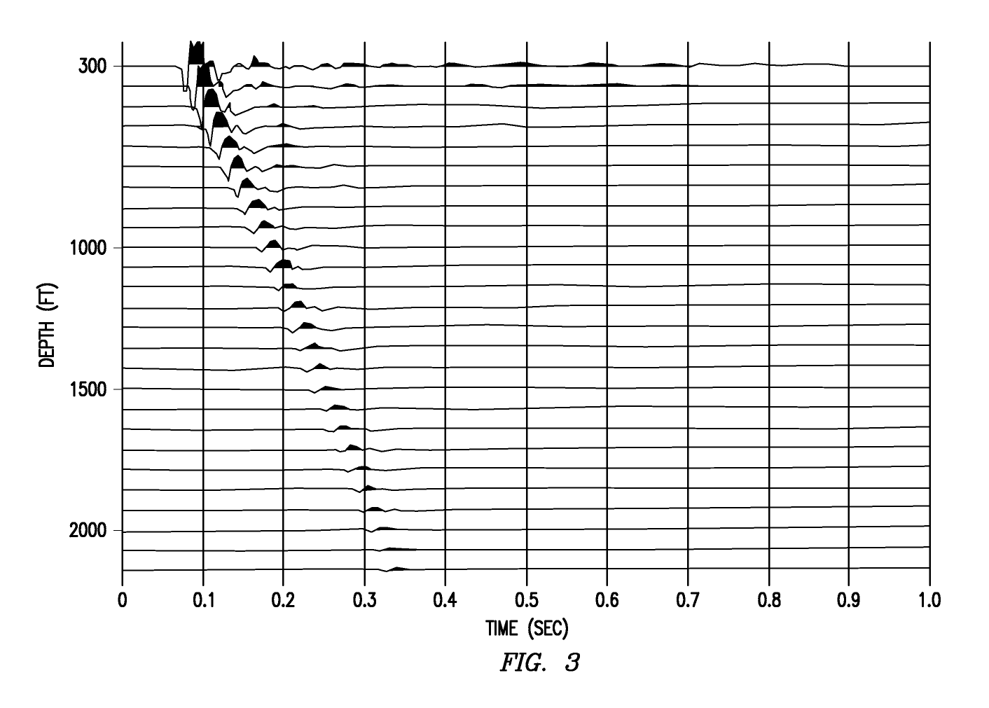

Please refer to FIG. 3a-b, which show a checkshot p/s wave diagram obtained from a wellbore. The checkshot traveltime t_{c}, represented in slowness (μs/ft), is determined by picking

### Obtaining Sonic Log Traveltime T_{S}

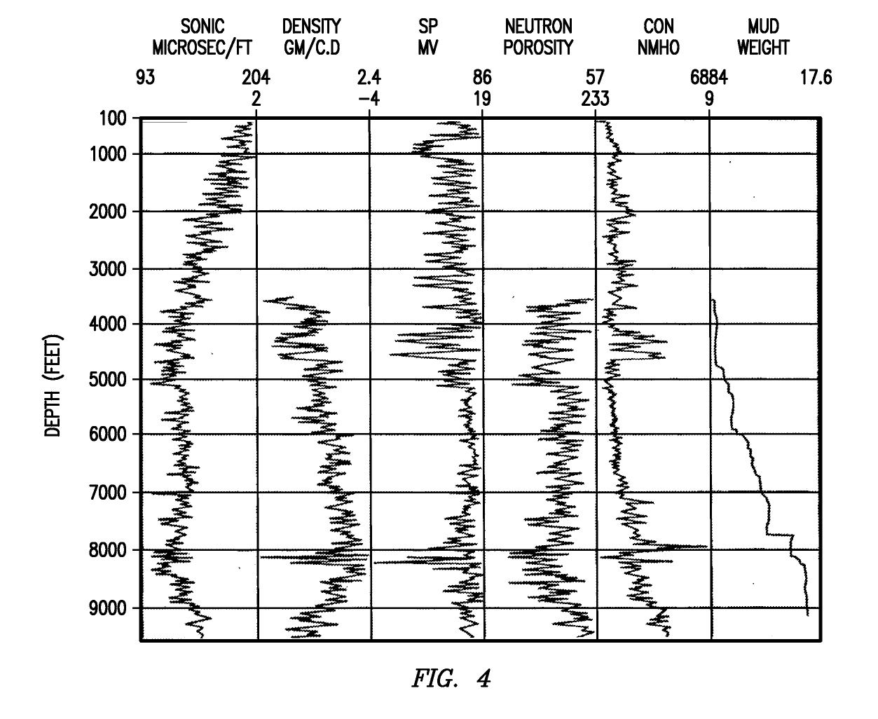

FIG. 4 shows a sample sonic log data from an existing wellbore. As shown therein, the leftmost column shows the sonic log. The traveltime tₛ can be determined by picking a specific depth on the sonic log and determine the slowness thereof.

### Resampling Sonic Log at Checkshot Depth

Based on the traveltime tₛ obtained from above, to have meaningful overlap with the checkshot survey, the sonic log is resampled at the depths where checkshot survey sensors were located, for example from 300 feet to 2200 feet with 100 feet interval.

### Applying the Algorithm

Based on the t_{c} and tₛ numbers, equations (1)-(4) can be applied to find the correction traveltime t_{corr}. Based on these approximations, equation (4) can be applied to find the estimated correction time t_{corr}^{est}, which is to be combined with t_{c} to give the actual travel time with minimized error.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

### REFERENCES

All of the references cited herein are expressly incorporated by reference. The discussion of any reference is not an admission that it is prior art to the present invention, especially any reference that may have a publication data after the priority date of this application. Incorporated references are listed again here for convenience:
1) U.S. Pat. No. 4,785,196, Reed, “Method and apparatus for converting seismic traces to synthetic well logs.” Conoco (1988).
2) U.S. Pat. No. 5,181,171, McCormack and Rock, “Adaptive network for automated first break picking of seismic refraction events and method of operating the same.” Atlantic Richfield Co. (1993).
3) U.S. Pat. No. 7,646,673, Akhmetsafin, et al., “Wave Analysis Using Phase Velocity Processing.” Baker Hughes Inc. (2010).
4) U.S. Pat. No. 7,660,199, Drew, “Microseismic Event Detection and Location by Continuous Map Migration.” Schlumberger Technology Corp. (2008).
5) Boschetti, et al., “A fractal-based algorithm for detecting first arrivals on seismic traces.” Geophysics, Vol. 61, No. 4, P. 1095-102 (1996).
6) Molyneux and Schmitt, “First-break timing: Arrival onset times by direct correlation.” Geophysics, Vol. 64, No. 5, P. 1492-501(1999).
7) Chen, et al., “Multi-window algorithm for detecting seismic first arrivals.” Evolving Geophysics Through Innovation, (2005).
8) Wong, et al., “Automatic time-picking of first arrivals on noisy microseismic data.” CREWES (2009).
9) U.S. Ser. No. 61/669,829, McLennan and Roy, “

What is claimed is:

1. A method for picking the first break arrival signal of a seismic survey, comprising the steps of:
a) obtaining a checkshot traveltime t_{c} from a checkshot survey time-depth relationship, wherein said checkshot survey is conducted using sensors located at different depths of a wellbore;
b) obtaining a sonic log traveltime tₛ from a sonic log time-depth relationship from the same wellbore; and
c) applying equation (4) to obtain a time-depth correction t_{corr}:
t_{corr}^{est}=[G^{T}G+λ²I]⁻¹G^{T}[a₀+a₁a₂D₁tₛ+a₃D₂tₛ−Gt_{c}] (4)
wherein G=D₂+a₁D₁, D₁ is the I^{th} derivative operator, a₁ is the I^{th} order regression coefficient, ε is the random measurement error.

2. The method of claim 1, further comprising performing step b-1) prior to step c):
b-1) resampling tₛ from said integrated sonic log at the same depths as the checkshot survey.

3. An improved method of picking the first break arrival signal of a seismic survey, the improvement comprising determining the first break by co-integrating a checkshot survey traveltime with a sonic log traveltime.

4. An improved method of picking the first break arrival signal of a seismic survey, the improvement comprising obtaining a checkshot survey and a sonic log, limiting the time-depth relationship resulting from the checkshot survey t_{c} and integrated sonic log tₛ to consistent time coverage; resampling the integrated sonic log at the checkshot measurement depths, thereby co-integrating a checkshot survey traveltime with a sonic log traveltime and picking a more accurate break arrival signal.
